(19) United States
(12) Patent Application Publication
(10) Pub. No.: US 2022/0177262 A1
(43) Pub. Date: Jun. 9, 2022

(54) ROPELESS ELEVATOR INTELLIGENT NORMAL FORCE RELEASE SUPERVISORY CONTROL

(71) Applicant: Otis Elevator Company, Farmington, CT (US)

(72) Inventors: Randy Roberts, Hebron, CT (US); Brad Guilani, Woodstock Valley, CT (US); Kiron Bhaskar, Farmington, CT (US)

(21) Appl. No.: 17/112,732

(22) Filed: Dec. 4, 2020

(51) Int. Cl. B66B 1/32; B66B 1/30; B66B 1/34; B66B 9/00; B66B 9/02

(52) U.S. Cl. CPC B66B 1/32; B66B 1/302; B66B 2201/242; B66B 9/003; B66B 9/02; B66B 1/3461

(57) ABSTRACT

An intelligent normal force release supervisor including: a processor; and a memory including computer-executable instructions that, when executed by the processor, cause the processor to perform operations, the operations including: receiving a signal from a dispatching controller that an elevator car and a propulsion system are going to park for a selected period of time; requesting a confirmation from a brake controller to confirm that a brake system of the elevator car and the propulsion system are deployed; receiving the confirmation from the brake controller to confirm that the brake system of the elevator car and the propulsion system are deployed; and transmitting a command to a normal force controller to reduce normal force on wheels of the propulsion system, wherein the normal force controller is configured to actuate a normal force generator to reduce the normal force on the wheels of the propulsion system in response to the command.

### BACKGROUND

The subject matter disclosed herein relates generally to the field of elevator systems, and specifically to a method and apparatus for alleviating pressure on wheels of elevator car propulsion systems.

Elevator cars are conventionally operated by ropes and counterweights, which typically only allow one elevator car in an elevator shaft at a single time. Ropeless elevator systems may allow for more than one elevator car in the elevator shaft at a single time.

### BRIEF SUMMARY

According to an embodiment, an intelligent normal force release supervisor is provided. The intelligent normal force release supervisor including: a processor; and a memory including computer-executable instructions that, when executed by the processor, cause the processor to perform operations, the operations including: receiving a signal from a dispatching controller that an elevator car and a propulsion system are going to park for a selected period of time; requesting a confirmation from a brake controller to confirm that a brake system of the elevator car and the propulsion system are deployed; receiving the confirmation from the brake controller to confirm that the brake system of the elevator car and the propulsion system are deployed; and transmitting a command to a normal force controller to reduce normal force on wheels of the propulsion system, wherein the normal force controller is configured to actuate a normal force generator to reduce the normal force on the wheels of the propulsion system in response to the command.

In addition to one or more of the features described herein, or as an alternative, further embodiments may include that the operations further include: informing a motion controller that the elevator car and the propulsion system cannot react to a request for motion, the motion controller being configured to control movement of the propulsion system and the elevator car through an elevator shaft.

In addition to one or more of the features described herein, or as an alternative, further embodiments may include that the operations further include: receiving a request for motion from the dispatching controller; transmitting a second command to the normal force controller to increase normal force on wheels of the propulsion system, wherein the normal force controller is configured to actuate a normal force generator to increase the normal force on the wheels of the propulsion system in response to the second command; receiving a second confirmation from the normal force controller that the normal force on the wheels of the propulsion system has been increased; and transmitting a third command to the brake controller to release the brake system of the elevator car and the propulsion system in response to the second confirmation.

In addition to one or more of the features described herein, or as an alternative, further embodiments may include that the operations further include: transmitting the request for motion to a motion controller of the elevator car and the propulsion system, the motion controller being configured to control movement of the propulsion system and the elevator car through an elevator shaft.

In addition to one or more of the features described herein, or as an alternative, further embodiments may include that the operations further include: instructing a motion controller to move the propulsion system and the elevator car to a parking area to park.

In addition to one or more of the features described herein, or as an alternative, further embodiments may include that the instructing the motion controller to move the propulsion system and the elevator car to the parking area to park further includes: instructing the motion controller to move the propulsion system and the elevator car from a first elevator shaft to a second elevator shaft.

In addition to one or more of the features described herein, or as an alternative, further embodiments may include that the propulsion system is a beam climber system configured to move the elevator car through an elevator shaft by climbing a first guide beam that extends vertically through the elevator shaft, the first guide beam including a first surface and a second surface opposite the first surface, the beam climber system including: a first wheel in contact with the first surface; and a first electric motor configured to rotate the first wheel.

According to another embodiment, a method of controlling an elevator system is provided. The method including: receiving a signal from a dispatching controller that an elevator car and a propulsion system are going to park for a selected period of time; requesting a confirmation from a brake controller to confirm that a brake system of the elevator car and the propulsion system are deployed; receiving the confirmation from the brake controller to confirm that the brake system of the elevator car and the propulsion system are deployed; and transmitting a command to a normal force controller to reduce normal force on wheels of the propulsion system, wherein the normal force controller is configured to actuate a normal force generator to reduce the normal force on the wheels of the propulsion system in response to the command.

In addition to one or more of the features described herein, or as an alternative, further embodiments may include informing a motion controller that the elevator car and the propulsion system cannot react to a request for motion, the motion controller being configured to control movement of the propulsion system and the elevator car through an elevator shaft.

In addition to one or more of the features described herein, or as an alternative, further embodiments may include receiving a request for motion from the dispatching controller; transmitting a second command to the normal force controller to increase normal force on wheels of the propulsion system, wherein the normal force controller is configured to actuate a normal force generator to increase the normal force on the wheels of the propulsion system in response to the second command; receiving a second confirmation from the normal force controller that the normal force on the wheels of the propulsion system has been increased; and transmitting a third command to the brake controller to release the brake system of the elevator car and the propulsion system in response to the second confirmation.

In addition to one or more of the features described herein, or as an alternative, further embodiments may include transmitting the request for motion to a motion controller of the elevator car and the propulsion system, the motion controller being configured to control movement of the propulsion system and the elevator car through an elevator shaft.

In addition to one or more of the features described herein, or as an alternative, further embodiments may include: instructing a motion controller to move the propulsion system and the elevator car to a parking area to park.

In addition to one or more of the features described herein, or as an alternative, further embodiments may include that the instructing the motion controller to move the propulsion system and the elevator car to the parking area to park further includes: instructing the motion controller to move the propulsion system and the elevator car from a first elevator shaft to a second elevator shaft.

In addition to one or more of the features described herein, or as an alternative, further embodiments may include transmitting a second command to the normal force controller to increase normal force on wheels of the propulsion system without receiving a request for motion from the dispatching controller, wherein the normal force controller is configured to actuate a normal force generator to increase the normal force on the wheels of the propulsion system in response to the second command; receiving a second confirmation from the normal force controller that the normal force on the wheels of the propulsion system has been increased; and transmitting a third command to the brake controller to release the brake system of the elevator car and the propulsion system in response to the second confirmation.

In addition to one or more of the features described herein, or as an alternative, further embodiments may include that the propulsion system is a beam climber system configured to move the elevator car through an elevator shaft by climbing a first guide beam that extends vertically through the elevator shaft, the first guide beam including a first surface and a second surface opposite the first surface, the beam climber system including: a first wheel in contact with the first surface; and a first electric motor configured to rotate the first wheel.

According to another embodiment, a computer program product embodied on a non-transitory computer readable medium is provided. The computer program product including instructions that, when executed by a processor, cause the processor to perform operations including: receiving a signal from a dispatching controller that an elevator car and a propulsion system are going to park for a selected period of time; requesting a confirmation from a brake controller to confirm that a brake system of the elevator car and the propulsion system are deployed; receiving the confirmation from the brake controller to confirm that the brake system of the elevator car and the propulsion system are deployed; and transmitting a command to a normal force controller to reduce normal force on wheels of the propulsion system, wherein the normal force controller is configured to actuate a normal force generator to reduce the normal force on the wheels of the propulsion system in response to the command.

In addition to one or more of the features described herein, or as an alternative, further embodiments may include that the operations further include: informing a motion controller that the elevator car and the propulsion system cannot react to a request for motion, the motion controller being configured to control movement of the propulsion system and the elevator car through an elevator shaft.

In addition to one or more of the features described herein, or as an alternative, further embodiments may include that the operations further include: receiving a request for motion from the dispatching controller; transmitting a second command to the normal force controller to increase normal force on wheels of the propulsion system, wherein the normal force controller is configured to actuate a normal force generator to increase the normal force on the wheels of the propulsion system in response to the second command; receiving a second confirmation from the normal force controller that the normal force on the wheels of the propulsion system has been increased; and transmitting a third command to the brake controller to release the brake system of the elevator car and the propulsion system in response to the second confirmation.

In addition to one or more of the features described herein, or as an alternative, further embodiments may include that the operations further include: transmitting the request for motion to a motion controller of the elevator car and the propulsion system, the motion controller being configured to control movement of the propulsion system and the elevator car through an elevator shaft.

In addition to one or more of the features described herein, or as an alternative, further embodiments may include that the operations further include: instructing a motion controller to move the propulsion system and the elevator car to a parking area to park.

Technical effects of embodiments of the present disclosure include utilizing an intelligent normal force release supervisor to coordinate the activation of brake and release of a normal force generator when an elevator car and a beam climber system are being placed in park.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system with a beam climber system, in accordance with an embodiment of the disclosure;

FIG. 2 illustrates a front view of a flat spot prevention system, in accordance with an embodiment of the disclosure; and

FIG. 3 is a flow chart of a method of operating an elevator system, in accordance with an embodiment of the disclosure.

### DETAILED DESCRIPTION

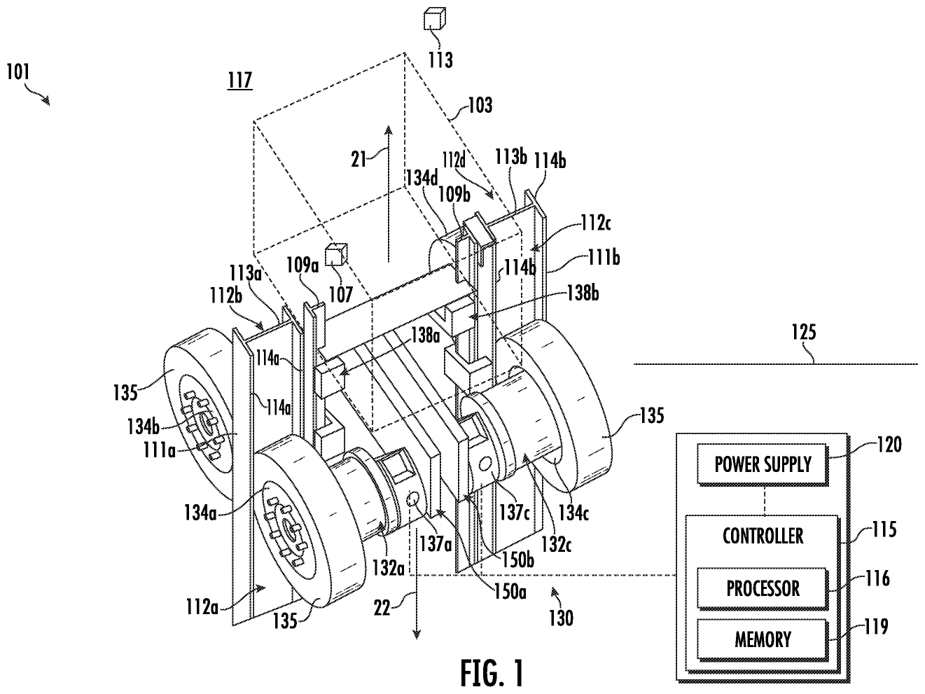

FIG. 1 is a perspective view of an elevator system 101 including an elevator car 103, a beam climber system 130, a controller 115, and a power source 120. Although illustrated in FIG. 1 as separate from the beam climber system 130, the embodiments described herein may be applicable to a controller 115 included in the beam climber system 130 (i.e., moving through an elevator shaft 117 with the beam climber system 130) and may also be applicable to a controller located off of the beam climber system 130 (i.e., remotely connected to the beam climber system 130 and stationary relative to the beam climber system 130). Although illustrated in FIG. 1 as separate from the beam climber system 130, the embodiments described herein may be applicable to a power source 120 included in the beam climber system 130 (i.e., moving through the elevator shaft 117 with the beam climber system 130) and may also be applicable to a power source located off of the beam climber system 130 (i.e., remotely connected to the beam climber system 130 and stationary relative to the beam climber system 130).

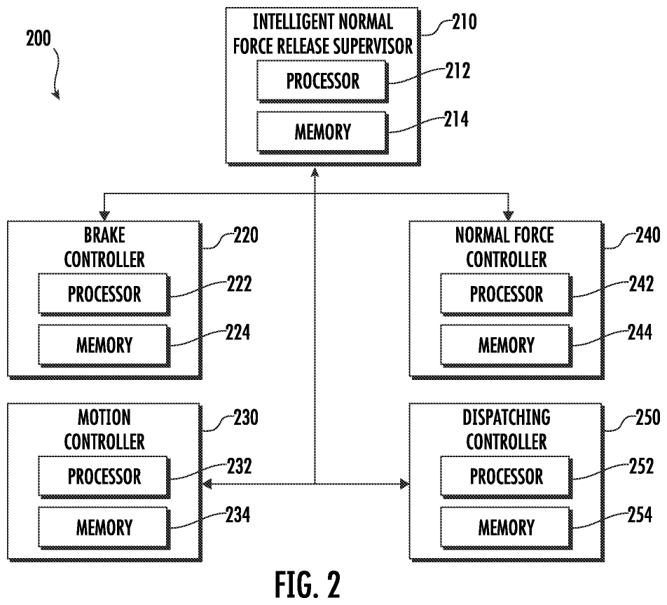

The beam climber system 130 is configured to move the elevator car 103 within the elevator shaft 117 and along guide rails 109a, 109b that extend vertically through the elevator shaft 117. In an embodiment, the guide rails 109a, 109b are T-beams. The beam climber system 130 includes one or more electric motors 132a, 132c. The electric motors 132a, 132c are configured to move the beam climber system 130 within the elevator shaft 117 by rotating one or more wheels 134a, 134b that are pressed against a guide beam 111a, 111b. In an embodiment, the guide beams 111a, 111b are I-beams. It is understood that while an I-beam is illustrated, any beam or similar structure may be utilized with the embodiment described herein. Friction between the wheels 134a, 134b, 134c, 134d driven by the electric motors 132a, 132c allows the wheels 134a, 134b, 134c, 134d to climb up 21 and down 22 the guide beams 111a, 111b. The guide beam extends vertically through the elevator shaft 117. It is understood that while two guide beams 111a, 111b are illustrated, the embodiments disclosed herein may be utilized with one or more guide beams. It is also understood that while two electric motors 132a, 132c are illustrated visible, the embodiments disclosed herein may be applicable to beam climber systems 130 having one or more electric motors. For example, the beam climber system 130 may have one electric motor for each of the four wheels 134a, 134b, 134c, 134d (e.g., see FIG. 2, which illustrates a first electric motor 132a, a second electric motor 132b, a third electric motor 132c, and a fourth electric motor 132d). The electrical motors 132a, 132c may be permanent magnet electrical motors, asynchronous motor, or any electrical motor known to one of skill in the art. In other embodiments, not illustrated herein, another configuration could have the powered wheels at two different vertical locations (i.e., at bottom and top of an elevator car 103).

The first guide beam 111a includes a web portion 113a and two flange portions 114a. The web portion 113a of the first guide beam 111a includes a first surface 112a and a second surface 112b opposite the first surface 112a. A first wheel 134a is in contact with the first surface 112a and a second wheel 134b is in contact with the second surface 112b. The first wheel 134a may be in contact with the first surface 112a through a tire 135 and the second wheel 134b may be in contact with the second surface 112b through a tire 135. The first wheel 134a is compressed against the first surface 112a of the first guide beam 111a by a first normal force generator 150a and the second wheel 134b is compressed against the second surface 112b of the first guide beam 111a by the first normal force generator 150a. The first normal force generator 150a compresses the first wheel 134a and the second wheel 134b together to clamp onto the web portion 113a of the first guide beam 111a. The first normal force generator 150a may be a pneumatic mechanism, a hydraulic mechanism, a turnbuckle mechanism, an electromechanical actuator mechanism, a motorized ball screw system, a hydraulic cylinder, a motorized spring setup, or any other known force actuation method. The first normal force generator 150a may be adjustable in real-time during operation of the elevator system 101 to control compression of the first wheel 134a and the second wheel 134b on the first guide beam 111a. The first wheel 134a and the second wheel 134b may each include a tire 135 to increase traction with the first guide beam 111a.

The first surface 112a and the second surface 112b extend vertically through the shaft 117, thus creating a track for the first wheel 134a and the second wheel 134b to ride on. The flange portions 114a may work as guardrails to help guide the wheels 134a, 134b along this track and thus help prevent the wheels 134a, 134b from running off track.

The first electric motor 132a is configured to rotate the first wheel 134a to climb up 21 or down 22 the first guide beam 111a. The first electric motor 132a may also include a first motor brake 137a to slow and stop rotation of the first electric motor 132a. The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109 proximate the elevator car 103.

The second guide beam 111b includes a web portion 113b and two flange portions 114b. The web portion 113b of the second guide beam 111b includes a first surface 112c and a second surface 112d opposite the first surface 112c. A third wheel 134c is in contact with the first surface 112c and a fourth wheel 134d is in contact with the second surface 112d. The third wheel 134c may be in contact with the first surface 112c through a tire 135 and the fourth wheel 134d may be in contact with the second surface 112d through a tire 135. A third wheel 134c is compressed against the first surface 112c of the second guide beam 111b by a second normal force generator 150b and a fourth wheel 134d is compressed against the second surface 112d of the second guide beam 111b by the second normal force generator 150b. The second normal force generator 150b compresses the third wheel 134c and the fourth wheel 134d together to clamp onto the web portion 113b of the second guide beam 111b. The second normal force generator 150b may be a pneumatic mechanism, a hydraulic mechanism, a turnbuckle mechanism, an electromechanical actuator mechanism, a motorized ball screw system, a hydraulic cylinder, a motorized spring setup, or any other known force actuation method. The second normal force generator 150b may be adjustable in real-time during operation of the elevator system 101 to control compression of the third wheel 134c and the fourth wheel 134d on the second guide beam 111b. The third wheel 134c and the fourth wheel 134d may each include a tire 135 to increase traction with the second guide beam 111b.

The first surface 112c and the second surface 112d extend vertically through the shaft 117, thus creating a track for the third wheel 134c and the fourth wheel 134d to ride on. The flange portions 114b may work as guardrails to help guide the wheels 134c, 134d along this track and thus help prevent the wheels 134c, 134d from running off track.

The second electric motor 132c is configured to rotate the third wheel 134c to climb up 21 or down 22 the second guide beam 111b. The second electric motor 132c may also include a third motor brake 137c to slow and stop rotation of the third motor 132c. The third motor brake 137c may be mechanically connected to the third motor 132c. The third motor brake 137c may be a clutch system, a disc brake system, drum brake system, a brake on a rotor of the second electric motor 132c, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109a proximate the elevator car 103.

The elevator system 101 may also include a position reference system 113. The position reference system 113 may be mounted on a fixed part at the top of the elevator shaft 117, such as on a support or guide rail 109, and may be configured to provide position signals related to a position of the elevator car 103 within the elevator shaft 117. In other embodiments, the position reference system 113 may be directly mounted to a moving component of the elevator system (e.g., the elevator car 103 or the beam climber system 130), or may be located in other positions and/or configurations as known in the art. The position reference system 113 can be any device or mechanism for monitoring a position of an elevator car within the elevator shaft 117, as known in the art. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 103 and the beam climber system 130. For example, the controller 115 may provide drive signals to the beam climber system 130 to control the acceleration, deceleration, leveling, stopping, etc. of the elevator car 103.

The controller 115 may also be configured to receive position signals from the position reference system 113 or any other desired position reference device.

When moving up 21 or down 22 within the elevator shaft 117 along the guide rails 109a, 109b, the elevator car 103 may stop at one or more landings 125 as controlled by the controller 115. In one embodiment, the controller 115 may be located remotely or in the cloud. In another embodiment, the controller 115 may be located on the beam climber system 130. In embodiment, the controller 115 controls on-board motion control of the beam climber system 115 (e.g., a supervisory function above the individual motor controllers).

The power supply 120 for the elevator system 101 may be any power source, including a power grid and/or battery power which, in combination with other components, is supplied to the beam climber system 130. In one embodiment, power source 120 may be located on the beam climber system 130. In an embodiment, the power supply 120 is a battery that is included in the beam climber system 130.

The elevator system 101 may also include an accelerometer 107 attached to the elevator car 103 or the beam climber system 130. The accelerometer 107 is configured to detect an acceleration and/or a speed of the elevator car 103 and the beam climber system 130.

As aforementioned, the first wheel 134a and the second wheel 134b are being compressed against the first guide beam 111a by the first normal force generator 150a and the third wheel 134c and the fourth wheel 134d are being compressed against the second guide beam by the second compression mechanism. This compression is required such that the first wheel 134a and second wheel 134b, maintain traction with the first guide beam 11a and the third wheel 134c and the fourth wheel 134d maintain traction with the second guide beam. This compression is fairly high to support the weight of both the elevator car 103 and the beam climber system 130. This high compression may lead to warping (also known as flat spotting) of the wheels 134a, 134b, 134c, 134d or tires 135 if the beam climber system 130 and elevator car 103 are not being utilized for long durations of time. The embodiments disclosed herein seek to address this warpage by alleviating the compression on the wheels 134a, 134b, 134c, 134d and tires 135 utilizing a wheel decompression system configured to move the wheels away from the guide beams 111a, 111b.

Referring now to FIG. 2 with continued reference to FIG. 1, a flat spot prevention system 200 for the elevator system 101 of FIG. 1 is illustrated, in accordance with an embodiment of the present disclosure. The flat spot prevention system 200 may include an intelligent normal force release supervisor 210, a brake controller 220, a motion controller 230, a normal force controller 240, and a dispatching controller 250. It should be appreciated that, although particular systems are separately defined in the schematic block diagrams, each or any of the systems may be otherwise combined or separated via hardware and/or software.

The intelligent normal force release supervisor 210 may be configured to control and coordinate all components of the flat spot prevention system 200. The intelligent normal force release supervisor 210 may be in communication with the brake controller 220, the motion controller 230, the normal force controller 240, and the dispatching controller 250. The intelligent normal force release supervisor 210 may be an electronic controller including a processor 212 and a memory 214 comprising computer-executable instructions (i.e., computer program product) that, when executed by the processor 212, cause the processor 212 to perform various operations. The processor 212 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 214 may be but is not limited to a random access memory (RAM), read only memory (ROM), or other electronic, optical, magnetic or any other computer readable medium.

The brake controller 220 is in communication with the guide rail brakes 138a, 138b. The brake controller 220 may be configured to control operation of the guide rail brake 138a, 138b. More specifically, the brake controller 220 may activate and deactivate the guide rail brakes 138a, 138b. The brake controller 220 may be in communication with the intelligent normal force release supervisor 210, the motion controller 230, the normal force controller 240, and the dispatching controller 250. The brake controller 220 may be an electronic controller including a processor 222 and a memory 224 comprising computer-executable instructions (i.e., computer program product) that, when executed by the processor 222, cause the processor 222 to perform various operations. The processor 222 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 224 may be but is not limited to a random access memory (RAM), read only memory (ROM), or other electronic, optical, magnetic or any other computer readable medium.

The motion controller 230 may be in communication with the beam climber system 130 and the elevator car 103. The motion controller 230 may be configured to control operation of the beam climber system 130 (i.e., propulsion system of the elevator car 103) and controls movement of the beam climber system 130 and the elevator car 103 through the elevator shaft 117 by rotations of the wheels 134a-134d. The motion controller 230 may be in communication with the intelligent normal force release supervisor 210, the brake controller 220, the normal force controller 240, and the dispatching controller 250. The motion controller 230 may be an electronic controller including a processor 232 and a memory 234 comprising computer-executable instructions (i.e., computer program product) that, when executed by the processor 232, cause the processor 232 to perform various operations. The processor 232 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 234 may be but is not limited to a random access memory (RAM), read only memory (ROM), or other electronic, optical, magnetic or any other computer readable medium.

The normal force controller 240 is in communication with the normal force generators 150a, 150b. The normal force controller 240 may be configured to control operation of the normal force generators 150a, 150b. More specifically, the normal force controller 240 may command the normal force generators 150a, 150b to increase or decrease the normal force generated by the normal force generators 150a, 150b. The normal force controller 240 may be in communication with the intelligent normal force release supervisor 210, the brake controller 220, the motion controller 230, and the dispatching controller 250. The normal force controller 240 may be an electronic controller including a processor 242 and a memory 244 comprising computer-executable instructions (i.e., computer program product) that, when executed by the processor 242, cause the processor 242 to perform various operations. The processor 242 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 244 may be but is not limited to a random access memory (RAM), read only memory (ROM), or other electronic, optical, magnetic or any other computer readable medium.

The dispatching controller 250 may be in communication with the elevator system 101, the beam climber system 130, and the elevator car 103. The dispatching controller 250 may be configured to control dispatching of the elevator car 103 and coordination of dispatching amongst multiple elevator cars 103 and/or elevator systems 101. The dispatching controller 250 may be in communication with the intelligent normal force release supervisor 210, the brake controller 220, the motion controller 230, and the normal force controller 240. The dispatching controller 250 may be an electronic controller including a processor 252 and a memory 254 comprising computer-executable instructions (i.e., computer program product) that, when executed by the processor 252, cause the processor 252 to perform various operations. The processor 252 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 254 may be but is not limited to a random access memory (RAM), read only memory (ROM), or other electronic, optical, magnetic or any other computer readable medium.

The intelligent normal force release supervisor 210 coordinates actions between the brake controller 220, the motion controller 230, the normal force controller 240, and the dispatching controller 250 to safely and effectively allow the normal force generators 150a, 150b to automatically release the normal forces on the wheels 134a, 134b, 134c, 134d of the beam climber system 130 when the beam climber system 130 is parked at a landing 125 with the guide rail brakes 138a, 138b engaged.

For example, upon arriving at a landing 125 when the intelligent normal force release supervisor 210 receives a signal from the dispatching controller 250 that the elevator car 103 and the beam climber system 130 is going to park 125 for a selected period of time, the intelligent normal force release supervisor 210 then asks the brake controller 220 to confirm the guide rail brake 138a, 138b are deployed. It then sends a command to the normal force controller 240 to reduce the normal forces on the wheels 134a, 134b, 134c, 134d and informs the motion controller 230 that the elevator car 103 and the beam climber system 130 cannot react to any motion request. In order for the elevator car 103 and the beam climber system 130 to revert back to operation the intelligent normal force release supervisor 210 then receives a request for motion from the dispatching controller 250, commands the normal force controller 240 to command the normal force generators 150a, 150b to provide the required normal force and then upon confirmation of those actions, coordinates the release of the guide rail brakes 138a, 138b with the brake controller 220, and provides motion commands to the motion controller 230.

Advantageously, the flat spot prevention system 200 helps with improving ride quality by reducing the chance of flat spots on tires, improves energy efficiency, and extends the life of the tires 135. Removing the high force loading on the wheels 134a-134d when parked will eliminate the potential for flat spotting the tires 135, which may create in-cab vibrations. The flat spot prevention system 200 also eliminates the need to cycle the beam climber system 130 during non-demand periods, which is energy inefficient. The flat sport prevention system 200 allows elevator cars 103 and beam climber systems 130 to be parked in non-used elevator shafts 117 during non-demand periods, not requiring them to continue to be operated without passengers, which is energy inefficient. Lastly, the concentrated loads and flat spots on the tires without this flat spot prevention system 200 may lead to an overall reduction in the life of the tire 135.

The flat spot prevention system 200 may be integrated into the controller 115 or exist as a separate component physically external to the controller 115.

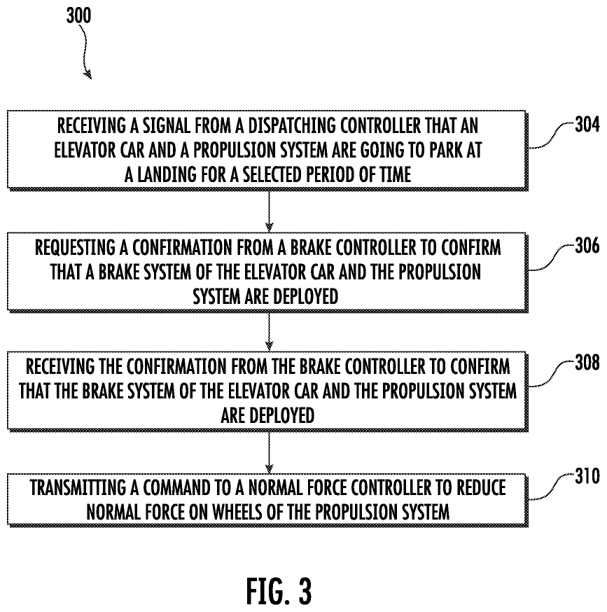

Referring now to FIG. 3, with continued reference to the previous FIGS., a flow chart of a method 300 operating an elevator system 101 is illustrated, in accordance with an embodiment of the disclosure. In an embodiment, method 300 is performed by flat spot prevention system 200 or more specifically, the intelligent normal force release supervisor 210.

At block 304, a signal is received from a dispatching controller 250 that an elevator car 103 and a propulsion system are going to park at a landing 125 for a selected period of time. Prior to parking, the method 300 may include that the motion controller 230 is instructed to move the propulsion system and the elevator car 103 to a parking area to park. The parking area may be a designated parking area outside of any elevator shaft 117 that is used to transport passengers, the designated parking area may be an elevator shaft 117 that is used to transport passengers, the designated parking area may be an entire elevator shaft 117 that is used to transport passengers, or the designated parking area may be a section of an elevator shaft 117 that is used to transport passengers. If an area of an elevator shaft 117 is utilized for parking, that area may be shut off to passenger travel during the time the area is utilized for parking. If an entire elevator shaft 117 is utilized for parking, that elevator shaft 117 may be shut off to passenger travel during the time the elevator shaft 117 is utilized for parking.

Further, the method 300 may comprise that the motion controller 230 is instructed to move the propulsion system and the elevator car 103 from a first elevator shaft 117 to a second elevator shaft 117. For example, the first elevator shaft 117 may be utilized for passenger traffic while the second elevator shaft 117 is utilized as a parking area.

At block 306, a confirmation is requested from a brake controller 220 to confirm that a brake system of the elevator car 103 and the propulsion system are deployed. The brake system may comprise the guide rail brakes 138a, 138b and/or any other brakes of the elevator system 101

At block 308, the confirmation is received from the brake controller 220 to confirm that the brake system of the elevator car 103 and the propulsion system are deployed (i.e., activated or engaged).

At block 310, a command is transmitted to a normal force controller to reduce normal force on wheels 134a-134d of the propulsion system. The normal force controller 240 is configured to actuate a normal force generator to reduce the normal force on the wheels 134a-134d of the propulsion system in response to the command.

The method 300 may further include that a motion controller 230 is informed that the elevator car 103 and the propulsion system cannot react to a request for motion. The motion controller 230 is configured to control movement of the propulsion system and the elevator car 103 through an elevator shaft 117.

The method 300 may further include that a request for motion is received from the dispatching controller 250 and a second command is transmitted to the normal force controller 240 to increase normal force on wheels 134a-134d of the propulsion system. The normal force controller 240 is configured to actuate a normal force generator 150a, 150b to increase the normal force on the wheels 134a-134d of the propulsion system in response to the second command. The normal force is increased enough so that the wheels 134a-134d maintain traction with the guide beams 111a, 111b in order for the propulsion system to move through the elevator shaft 117. A second confirmation may be received from the normal force controller 240 that the normal force on the wheels 134a-134d of the propulsion system has been increased and a third command is transmitted to the brake controller 220 to release the brake system of the elevator car 103 and the propulsion system in response to the second confirmation.

The method 300 may further comprise that the beam climber system 130 may perform a self-check to check functionality of the beam climber system 130 if the elevator car 130 and the beam climber system 130 are in park for extended durations.

Therefore method 300 may further include that a second command is transmitted to the normal force controller 240 to increase normal force on wheels 134a-134d of the propulsion system without a request for motion is received from the dispatching controller 250. The normal force controller 240 is configured to actuate a normal force generator 150a, 150b to increase the normal force on the wheels 134a-134d of the propulsion system in response to the second command. The normal force is increased enough so that the wheels 134a-134d maintain traction with the guide beams 111a, 111b in order for the propulsion system to move through the elevator shaft 117. A second confirmation may be received from the normal force controller 240 that the normal force on the wheels 134a-134d of the propulsion system has been increased. A third command is transmitted to the brake controller 220 to release the brake system of the elevator car 103 and the propulsion system in response to the second confirmation.

Next, the beam climber system 130 may then remain stationary, re-apply the brake system, and release the normal force on the wheels 134a-134d. Alternatively, the beam climber system 130 may move through the elevator shaft 117 to check functionality of other components, such as, for example, the electric motors 132a, 132b. Then, the beam climber system 130 re-apply the brake system, and release the normal force on the wheels 134a-134d This self-check may ensure that the beam climber system 130 and elevator car 103 can be put back into service when needed.

The method 300 may further include that the request for motion is transmitted to a motion controller 230 of the elevator car 103 and the propulsion system.

In an embodiment, the propulsion system of method 300 is a beam climber system 130 configured to move the elevator car 103 through an elevator shaft 117 by climbing a first guide beam 111a that extends vertically through the elevator shaft 117. The first guide beam 111a including a first surface 112a and a second surface 112b opposite the first surface 112a. The beam climber system 130 including a first wheel 134a in contact with the first surface 112a and a first electric motor 132a configured to rotate the first wheel 134a.

While the above description has described the flow process of FIG. 3 in a particular order, it should be appreciated that unless otherwise specifically required in the attached claims that the ordering of the steps may be varied.

The present invention may be a system, a method, and/or a computer program product at any possible technical detail level of integration. The computer program product may include a computer readable storage medium (or media) having computer readable program instructions thereon for causing a processor to carry out aspects of the present invention.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the

What is claimed is:

1. An intelligent normal force release supervisor comprising:
a processor; and
a memory comprising computer-executable instructions that, when executed by the processor, cause the processor to perform operations, the operations comprising:
receiving a signal from a dispatching controller that an elevator car and a propulsion system are going to park for a selected period of time;
requesting a confirmation from a brake controller to confirm that a brake system of the elevator car and the propulsion system are deployed;
receiving the confirmation from the brake controller to confirm that the brake system of the elevator car and the propulsion system are deployed; and
transmitting a command to a normal force controller to reduce normal force on wheels of the propulsion system,
wherein the normal force controller is configured to actuate a normal force generator to reduce the normal force on the wheels of the propulsion system in response to the command.

2. The intelligent normal force release supervisor of claim 1, wherein the operations further comprise:
informing a motion controller that the elevator car and the propulsion system cannot react to a request for motion, the motion controller being configured to control movement of the propulsion system and the elevator car through an elevator shaft.

3. The intelligent normal force release supervisor of claim 1, wherein the operations further comprise:
receiving a request for motion from the dispatching controller;
transmitting a second command to the normal force controller to increase normal force on wheels of the propulsion system, wherein the normal force controller is configured to actuate a normal force generator to increase the normal force on the wheels of the propulsion system in response to the second command;
receiving a second confirmation from the normal force controller that the normal force on the wheels of the propulsion system has been increased; and
transmitting a third command to the brake controller to release the brake system of the elevator car and the propulsion system in response to the second confirmation.

4. The intelligent normal force release supervisor of claim 3, wherein the operations further comprise:
transmitting the request for motion to a motion controller of the elevator car and the propulsion system, the motion controller being configured to control movement of the propulsion system and the elevator car through an elevator shaft.

5. The intelligent normal force release supervisor of claim 1, wherein the operations further comprise:
instructing a motion controller to move the propulsion system and the elevator car to a parking area to park.

6. The intelligent normal force release supervisor of claim 5, wherein the instructing the motion controller to move the propulsion system and the elevator car to the parking area to park further comprises:
instructing the motion controller to move the propulsion system and the elevator car from a first elevator shaft to a second elevator shaft.

7. The intelligent normal force release supervisor of claim 1, wherein the propulsion system is a beam climber system configured to move the elevator car through an elevator shaft by climbing a first guide beam that extends vertically through the elevator shaft, the first guide beam comprising a first surface and a second surface opposite the first surface, the beam climber system comprising:
a first wheel in contact with the first surface; and
a first electric motor configured to rotate the first wheel.

8. A method of controlling an elevator system, the method comprising:
receiving a signal from a dispatching controller that an elevator car and a propulsion system are going to park for a selected period of time;
requesting a confirmation from a brake controller to confirm that a brake system of the elevator car and the propulsion system are deployed;
receiving the confirmation from the brake controller to confirm that the brake system of the elevator car and the propulsion system are deployed; and
transmitting a command to a normal force controller to reduce normal force on wheels of the propulsion system,
wherein the normal force controller is configured to actuate a normal force generator to reduce the normal force on the wheels of the propulsion system in response to the command.

9. The method of claim 8, further comprising:
informing a motion controller that the elevator car and the propulsion system cannot react to a request for motion, the motion controller being configured to control movement of the propulsion system and the elevator car through an elevator shaft.

10. The method of claim 8, further comprising:
receiving a request for motion from the dispatching controller;
transmitting a second command to the normal force controller to increase normal force on wheels of the propulsion system, wherein the normal force controller is configured to actuate a normal force generator to increase the normal force on the wheels of the propulsion system in response to the second command;
receiving a second confirmation from the normal force controller that the normal force on the wheels of the propulsion system has been increased; and
transmitting a third command to the brake controller to release the brake system of the elevator car and the propulsion system in response to the second confirmation.

11. The method of claim 10, further comprising:
transmitting the request for motion to a motion controller of the elevator car and the propulsion system, the motion controller being configured to control movement of the propulsion system and the elevator car through an elevator shaft.

12. The method of claim 8, further comprising:
instructing a motion controller to move the propulsion system and the elevator car to a parking area to park.

13. The method of claim 12, wherein the instructing the motion controller to move the propulsion system and the elevator car to the parking area to park further comprises:
instructing the motion controller to move the propulsion system and the elevator car from a first elevator shaft to a second elevator shaft.

14. The method of claim 8, further comprising:
transmitting a second command to the normal force controller to increase normal force on wheels of the propulsion system without receiving a request for motion from the dispatching controller, wherein the normal force controller is configured to actuate a normal force generator to increase the normal force on the wheels of the propulsion system in response to the second command;
receiving a second confirmation from the normal force controller that the normal force on the wheels of the propulsion system has been increased; and
transmitting a third command to the brake controller to release the brake system of the elevator car and the propulsion system in response to the second confirmation.

15. The method of claim 8, wherein the propulsion system is a beam climber system configured to move the elevator car through an elevator shaft by climbing a first guide beam that extends vertically through the elevator shaft, the first guide beam comprising a first surface and a second surface opposite the first surface, the beam climber system comprising:
a first wheel in contact with the first surface; and
a first electric motor configured to rotate the first wheel.

16. A computer program product embodied on a non-transitory computer readable medium, the computer program product including instructions that, when executed by a processor, cause the processor to perform operations comprising:
receiving a signal from a dispatching controller that an elevator car and a propulsion system are going to park for a selected period of time;
requesting a confirmation from a brake controller to confirm that a brake system of the elevator car and the propulsion system are deployed;
receiving the confirmation from the brake controller to confirm that the brake system of the elevator car and the propulsion system are deployed; and
transmitting a command to a normal force controller to reduce normal force on wheels of the propulsion system,
wherein the normal force controller is configured to actuate a normal force generator to reduce the normal force on the wheels of the propulsion system in response to the command.

17. The computer program product of claim 16, wherein the operations further comprise:
informing a motion controller that the elevator car and the propulsion system cannot react to a request for motion, the motion controller being configured to control movement of the propulsion system and the elevator car through an elevator shaft.

18. The computer program product of claim 16, wherein the operations further comprise:
receiving a request for motion from the dispatching controller;
transmitting a second command to the normal force controller to increase normal force on wheels of the propulsion system, wherein the normal force controller is configured to actuate a normal force generator to increase the normal force on the wheels of the propulsion system in response to the second command;
receiving a second confirmation from the normal force controller that the normal force on the wheels of the propulsion system has been increased; and
transmitting a third command to the brake controller to release the brake system of the elevator car and the propulsion system in response to the second confirmation.

19. The computer program product of claim 18, wherein the operations further comprise:
transmitting the request for motion to a motion controller of the elevator car and the propulsion system, the motion controller being configured to control movement of the propulsion system and the elevator car through an elevator shaft.

20. The computer program product of claim 16, wherein the operations further comprise:
instructing a motion controller to move the propulsion system and the elevator car to a parking area to park.
